(19) United States
(12) Patent Application Publication
(10) Pub. No.: US 2005/0012961 A1
(43) Pub. Date: Jan. 20, 2005

(54) Arranging components on a sheet

(76) Inventor: Rohan John Holt, Fairy Meadow (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/846,166

(22) Filed: May 14, 2004

(30) Foreign Application Priority Data
May 14, 2003 (AU) 2003902362

(51) Int. Cl. G06F 15/00; B32B 3/00

(52) U.S. Cl. 358/1.18; 358/1.12

(57) ABSTRACT

The invention concerns a method for arranging of components on a sheet. For example, the arranging of rectangular pages onto a press sheet so that they can be printed onto the press sheet. The invention also concerns a computer program and system for arranging components on a sheet. The invention involves entering specifications of each type of component, including dimensions and quantity. Entering specifications of the sheet, including dimensions. Calculating a whole number ratio of components that is proportional to the quantity requirement of the components and multiplying it by the largest factor that results in the calculated total area of the components in the ratio not exceeding the calculated area of the sheet. Setting testing rules, including a preferred position rule, preferred cut orientation rule and a preferred sheet resulting from a cut rule. And, testing the ratio by attempting to arrange components as required by the ratio on the sheet by applying the testing rules.

### BACKGROUND OF INVENTION

1. Filed of the Invention

The invention concerns a method for arranging of components on a sheet. For example, the arranging of rectangular pages onto a press sheet so that they can be printed onto the press sheet. The invention also concerns a computer program and system for arranging components on a sheet.

2. Description of the Related Technology

Many factors must be taken into consideration when arranging components on a press sheet for printing. FIG. 1a) to i) illustrates some of these considerations.

In FIG. 1a) the greyed areas on the sheet 10 define an image area rectangle 12 outside of which an image cannot be printed. An image contained within a component can not be arranged outside this image area rectangle 12. This can be due to the gripping requirement of press printing the sheet 10.

The rectangle outline 14 in FIG. 1b) represents a minimum trim allowance for a sheet 10. A component's trim area 18 cannot be arranged on the sheet 10 outside this sheet trim allowance 14, but the bleed portion of the component's image may fall outside the sheet trim allowance 14.

FIGS. 1c), d) and e) illustrate the possible bleed specifications of a component 16. FIG. 1c) shows a component 16 having no bleed requirement, the image 20 being a specified distance within the trim area 18 of the component 16. In FIG. 1d), the component 16 has a uniform bleed requirement, the image 20 extending a uniform distance over the trim area 18 of the component 16. In FIG. 1e), the component 16 has non-uniform image area 20 that bleeds over one side of the trim area 18 of the component 16.

FIGS. 1f), g) and h) illustrate the possible arrangement of components 16 with varying bleed requirements onto a sheet 10, having both an image area rectangle 12 and trim allowance 14. In FIG. 1f) components 16 have bleed requirements, so the component 16 is positioned either a distance from the image area rectangle 12 equal to the distance of the bleed allowance (as shown on left) or with the edge of the trim rectangle 18 of the component 16 aligned with the trim allowance 14 of the sheet 10.

In FIG. 1g) the components 16 have no bleed requirements, so the component 16 is positioned so that the trim area 18 of the component 16 is aligned with the trim allowance 14 of the sheet 10 (as shown on left and right), ensuring that the image area 20 of the component 16 does not extend outside the image area of the rectangle 14 of the sheet 10.

In FIG. 1h) the components 16 have some bleed requirements. In positioning these components 16, the same rules apply as in FIGS. 1f) and g) depending on which edge of the component 16 is being aligned.

FIG. 1i) illustrates the possible positioning of a folded and post-fold trimmed component with four visible pages each having no bleed requirement and a post-fold offcut area 22. In this case, the outer edge of the post-fold offcut area 22 is aligned with the physical edge of the sheet 10, ensuring that the trim rectangle 18 of each page does not extend outside the trim allowance 14 of the sheet 10 and the image area 20 of each page does not extend outside the image area rectangle 12. Non-folded components may likewise have offcut areas that extend beyond the trim allowance 14 of the sheet 10.

### SUMMARY OF CERTAIN INVENTIVE ASPECTS OF THE INVENTION

One aspect of the invention provides a method for arranging components on a sheet In one embodiment, the method comprises entering specifications of each type of component, including dimensions and quantity; entering specifications of the sheet, including dimensions; calculating a whole number ratio of components that is proportional to the quantity requirement of the components and multiplying it by the largest factor that results in the calculated total area of the components in the ratio not exceeding the calculated area of the sheet; setting testing rules, including a preferred position rule, preferred cut orientation rule and a preferred sheet resulting from a cut rule; and testing the ratio by attempting to arrange components as required by the ratio on the sheet by applying the testing rules.

Another aspect of the invention provides a method that attempts to arrange components on a sheet in a manner that is both efficient in terms of processing and in terms of sheet usage and cost. It is a further advantage of least one embodiment of the invention that the different components are arranged together on the one sheet in a manner that corresponds to the proportional quantities required for each component.

Testing may be performed through the simulation of arranging components on the sheet in an electronic environment.

Specifications

The method may further comprise the step of entering specifications of a plant, both equipment and resources, that will arrange the components onto the sheet, including possible sheet sizes that can be used by the plant, trim allowances and non-image allowances for these sheets, and possible press production methods. The plant may arrange the instances by printing them.

Each component may be rectangular in shape, and may be folded and possibly trimmed after folding, and may possibly be bound, laminated, embossed, foil stamped, perforated or shape cut. Specifications of the component may also include bleed requirement, grain requirement, trim requirement, offcut allowance and whether the image area is symmetrical. A component may have instances where each instance may share the same specifications as the corresponding component together with additional arrangement information. Arrangement information may include a rotation of the instance, a x-coordinate and y-coordinate of the lower left hand corner of the instance, and the number of that instance out of the quantity required of the component.

Specifications of the sheet may include dimensions, grain, orientation, trim requirement and image area—the latter two usually resulting from specifications of plant equipment that process the sheet. Area specification of the component and sheet may be derived from height and width information.

Ratios (ComponentQuantities)

The factor may be a whole number.

The step of creating a whole number ratio may include consideration of the bleed requirement of the component when calculating the area of the component.

The step of calculating the ratio may also include calculating further ratios to create a list of ratios. All ratios of components in the list may be whole number ratios, may be proportional to the quantity requirements of the components, and the total area of the components in each ratio may not exceed the area of the sheet. All component ratios may be proportional to the quantity requirements of the components allowing for previously assigned components and these previously assigned components may be arranged manually.

Calculating further ratios may begin with a basic ratio. The basic ratio is calculated by assigning to the component that requires the smallest quantity the number 1 in the basic ratio and calculating a substantially proportional number for each remaining component in the basic ratio based on their quantity requirement. Further ratios may be calculated by multiplying the basic ratio by a whole number factor. The factor may initially be equal to 1 and systematically increased by 1 for each new ratio calculated. The calculating of further ratios may cease when for the next ratio to be calculated the calculated total area of the components in that ratio exceeds the calculated area of the sheet.

The maximum factor may be the largest factor used to multiply the basic ratio to create a ratio where the calculated total area of the components in that ratio does not exceed the calculated area of the sheet.

The ratio may be the ratio where the number representing the component requiring the smallest quantity is higher than the number representing that same component in other ratios included in the list.

Even further intermediate ratios may be calculated. Yet, even further intermediate ratios may be calculated between the basic ratio and the ratio containing 1 of each component. These intermediate ratios may also only contain whole numbers and must be proportional to the quantity requirements of the components.

The list of ratios may be ordered from the ratio that was calculated from the largest factor, to the ratio that was calculated from the smallest factor.

Collections (ComponentSizes and TestSolutions)

The method may also comprise the step of calculating a collection of all possible component orientation combinations for the ratio given the grain, and bleed symmetry specification of each component. The step of calculating a collection of combinations may further include the calculation of all possible component orientation combinations for ratios in the ratio list.

Before calculating combinations, the method may further comprise the step of combining identical components to treat them as one component with an increased quantity specification. This may be done to increase the efficiency of the method so as to avoid duplication in the processing of components with identical specifications without the loss in sheet usage. Further, all instances of components that have identical specifications can then be arranged in the same orientation which will assist the efficient future processing of these components once arranged on the sheet.

Possible orientations may include rotations of each component to either 0°, 90°, 180° or 270°. The number of combinations may be dictated by the specifications of the components. If a component has a specific grain requirement (i.e. one dimension of the component must be aligned with the grain of the sheet), then no combination may include the rotation of that component to 90° or 270° from the aligned position. If a component has no grain requirement and an unsymmetrical bleed requirement (e.g. the image extends over only one edge of the component), then combinations may be created to include all possible rotations of that component.

The method may further comprise the steps of ordering the components within each combination, in order of largest to smallest based on component dimensions.

Combinations may be calculated initially for the ratio. Combinations may then be progressively calculated for other ratios in the list towards the ratio that was calculated from the smallest factor. For efficiency, combinations may be calculated for a sequence of ratios in the list, the sequence not including all ratios in the list. If required, combinations for the ratios not included in the sequence may be calculated later.

After calculating the collection of combinations, the method may further comprise the step of expanding each combination, to specify for each component in the combination a number of instances as required by the corresponding ratio and the orientation of each instance. Instances within the expanded combination may be ordered from largest to the smallest based on dimensions. Within an expanded combination, the orientation of each instance of the same component may all be the same. The orientation of each instance of components combined to be treated as the same may all be the same. Any instances of a component that was combined to be treated the same may be separately identified in the expanded combination to indicate which of the combined components that instance is an instance of.

The method may further calculate the rotation of components in an expanded combination based on certain testing rules being applied. Where a large number of identical sized components are to be printed, for instance business cards, the components may be arranged in a grid forming rows and columns. The component rotations may be set so that every possible rotation for each row or column of components being arranged is tested. The rotations tested may be limited to 0° and 90° unless any component has non-symmetrical bleeds in which case 180° and 270° rotations may also be tested. Component grain requirements may also limit the rotations tested.

Testing Rules

The testing rules may be set based on the entered specifications, such as the orientation of the sheet. The testing may be re-set during testing based on the specifications of a sheet resulting from a cut. The testing rules may be dependant on one another.

An attempt to arrange a component on the sheet may include testing to see whether the component fits within the area of the sheet. A component is successfully arranged if it fits within the sheet and the trim allowance and image area specifications of the component and sheet have been considered.

The preferred position rule may specify a preferred position that an attempt to arrange a component is to be made. This position may be the bottom left hand corner of the sheet or a sheet resulting from a cut. The preferred position rule may specify a prioritised order of positions for attempts to arrange a component to be made.

The preferred cut orientation rule may specify the orientation of a cut made to remove a successfully arranged component from the sheet or sheet resulting from a previous cut. The preferred orientation rule may specify that the cut is vertically orientated or horizontally orientated. The preferred orientation rule may specify a prioritised order of cut orientations to be attempted. The preferred orientation rule may further specify that the cut is aligned with a side of the successfully arranged component not sharing an edge with an edge of the sheet.

The preferred sheet resulting from a cut rule may specify which cut sheet testing of the ratio will continue on. The preferred sheet rule may depend on the preferred cut orientation rule. The preferred sheet rule may specify that only the sheets resulting from only one orientation cut will be used in the continued testing of the ratio. The preferred sheet rule may specify a prioritised order for testing possible sheets resulting from a cut. The preferred sheet rule may specify a prioritised order for testing possible sheets resulting from any possible cut.

The testing rules may specify whether only one possible position, cut orientation is tested, or all alternatives are tested in a prioritised order.

The testing of the ratio may be based on the collection of component orientation combinations calculated for that ratio, where each instance of a component within each combination is arranged in the orientation specified by the combination. The testing of these combinations may be performed in sequence. Testing of these combinations may cease once all combinations in the collection have been tested.

The method may further comprise the testing of further ratios from the ratio list in the same manner as the ratio is tested. These further ratios may be tested in order from the ratio that was calculated from the largest factor, to the ratio that was calculated from the smallest factor. Alternatively, the further ratios may be tested in sequence, the sequence not including all ratios in the list. The next ratio in the sequence may be chosen based on the results produced by the previously tested ratio.

Testing of ratios based on combinations may be based on the expanded combinations. An expanded combination may be tested by arranging a first instance in the expanded combination on the sheet. If the arrangement of the first instance on the sheet is successful the method may further comprise the cutting of the instance from the sheet, using two straight cuts in sequence. The selection of the cut to be tested may be made according to the preferred cut orientation rule.

The method may further comprise analysing the cut sheets to discard any cut sheet that is too small to fit the smallest instance in the expanded combination that is not yet arranged on the sheet.

If only one cut sheet remains undiscarded from both the possible vertical and horizontal cut, the preferred sheet rule may include discarding the cut sheet that has the smallest area.

Each cut sheet may become a new sheet on which the testing of any unarranged instances in the expanded combination currently being tested may continue. The selection of a cut sheet may be made according to the preferred sheet rule.

Testing may also continue on any new cut sheets that may result from the next successful arrangement of the instance, initially on one such cut sheet according to the preferred sheet rule. This testing may continue until the testing of the combination on that sequence of cut sheets is either successful or fails as there remain unarranged instances and no remaining cut sheets.

Testing of the expanded combination may then continue on a cut sheet selected by the preferred sheet rule that was previously created but not tested using the instances from the expanded combination that were unarranged at the time the cut sheet was made. Testing may continue until each possible cut sheet has been tested.

The method may further allow components to be pre-arranged on the sheet which may be done manually or automatically. The pre-arranged instances may be removed from the sheet in the manner determined by the preferred cut orientation rule and all possible sets of sheets resulting from the cuts may be calculated and made available for testing placement of remaining instances.

Identifying

The method may further comprise the step of identifying all combinations that can be successfully arranged on the sheet.

If all instances of each component of a combination are successfully arranged in at least one arrangement on the sheet, the combination is successful. If no successful arrangement of all instances of each component is made, the combination fails.

Upon the success or failure of a combination, testing may continue on any untested combination of the ratio. Once all combinations of the ratio have been tested, testing may continue in the same manner on any untested ratios in the order that they appear on the list.

Once a successful combination is identified, the method may further comprise the step of storing arrangement information for each instance in the combination. If a combination is successful through more than one arrangement of the instances, arrangement information is also stored for each alternative successful arrangement.

From the stored arrangement information, the method may further comprise the step of calculating the percentage sheet usage by comparing the calculated total area of the components arranged on the sheet to the calculated sheet area for each successful arrangement. From the stored arrangement information, the method may further comprise the step of calculating an estimated manufacturing cost of each successful arrangement. The method may further comprise the step of identifying the most optimal solution, that solution having the highest percentage of sheet usage or the lowest estimated manufacturing cost. Alternatively, a solution may be based on the components to be arranged and the limitations of the imaging or printing technology, or on the postpress equipment limitations.

Another aspect of the invention provides a computer program that is able to execute the method as described above.

Still another aspect of the invention provides a system having means to perform the method as described above.

### BRIEF DESCRIPTION OF THE DRAWINGS

Various embodiments of the invention will now be described with reference to the accompanying drawings, in which:

FIGS. 1a) to i) are illustrations showing the various considerations when arranging components on the press sheet for printing;

FIGS. 2a) to f) are a simplified flowchart of the present invention;

FIG. 3 is a diagram showing the two sets of possible cut sheets after the successful arrangement of a ComponentInstance; and

FIG. 4 is a tree diagram showing the possible creation and processing order of cut sheets.

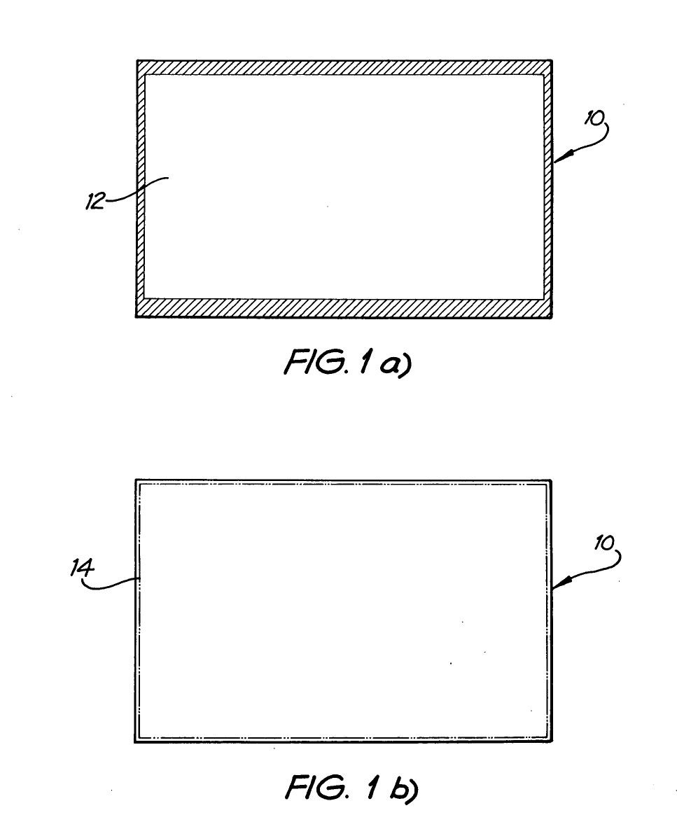

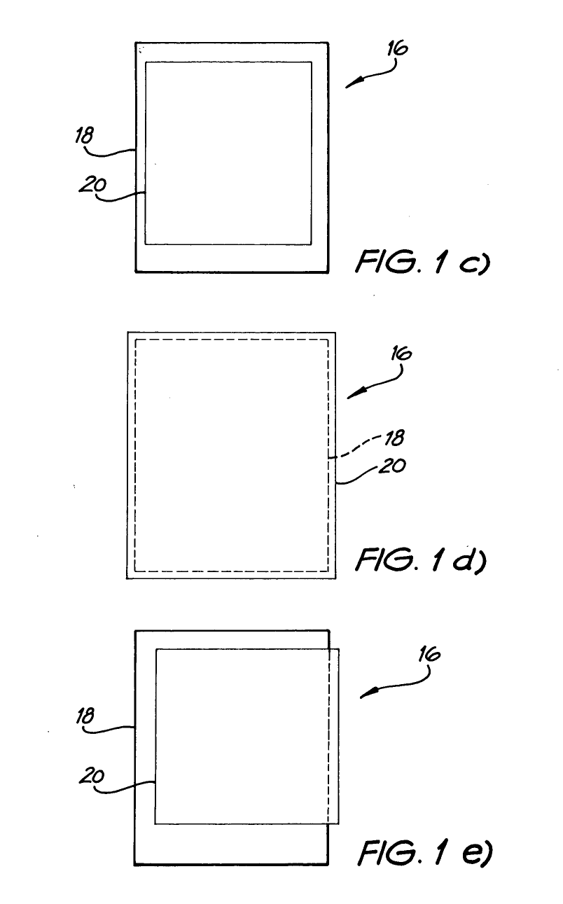

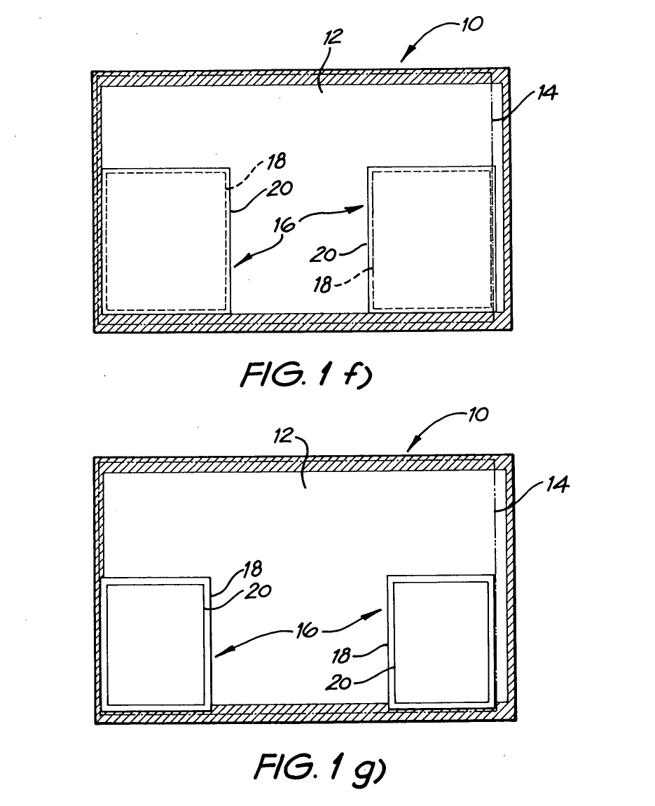

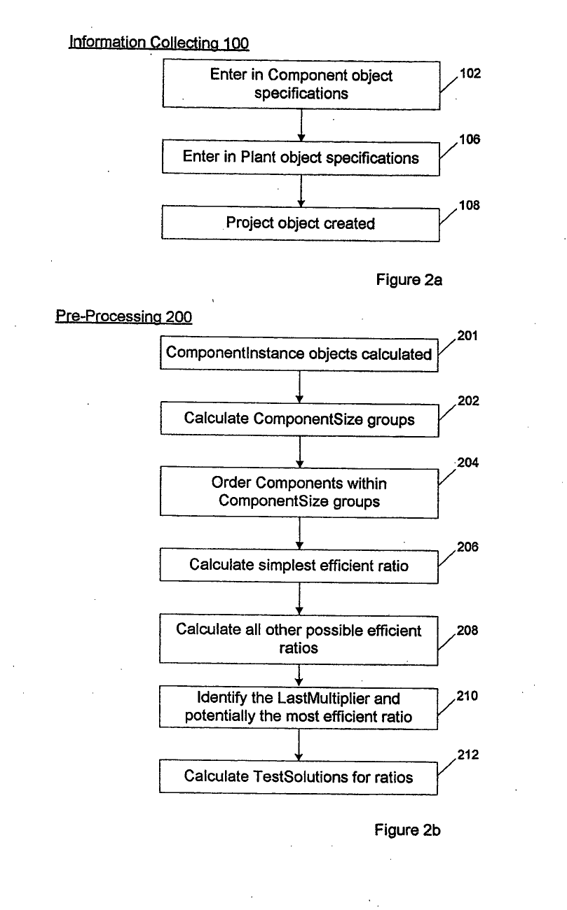

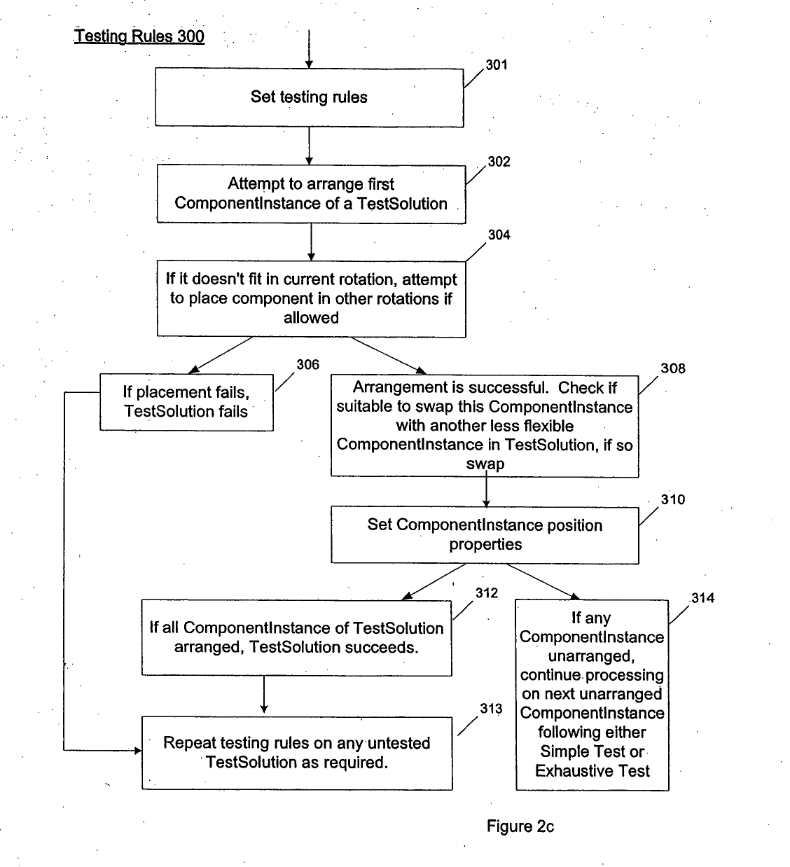

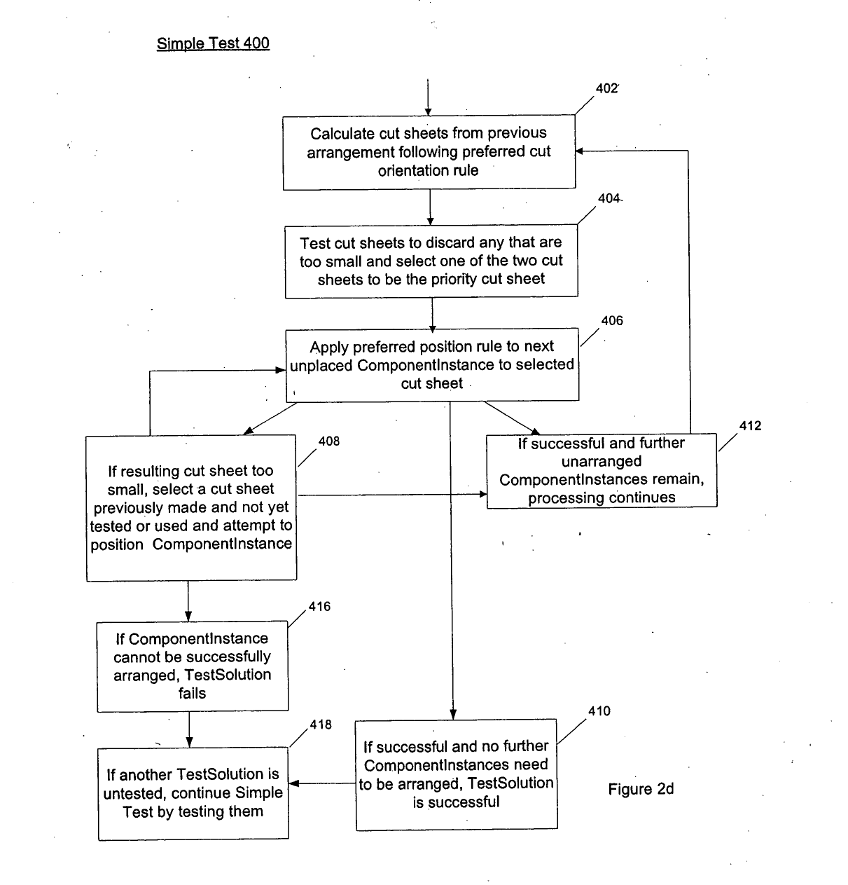

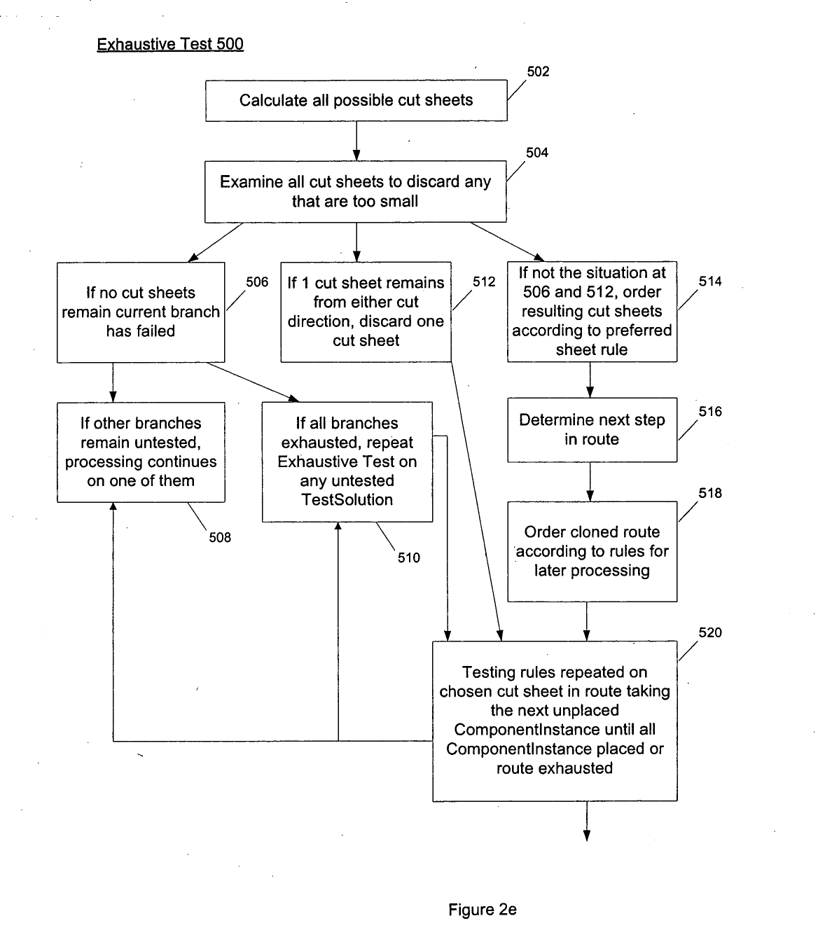

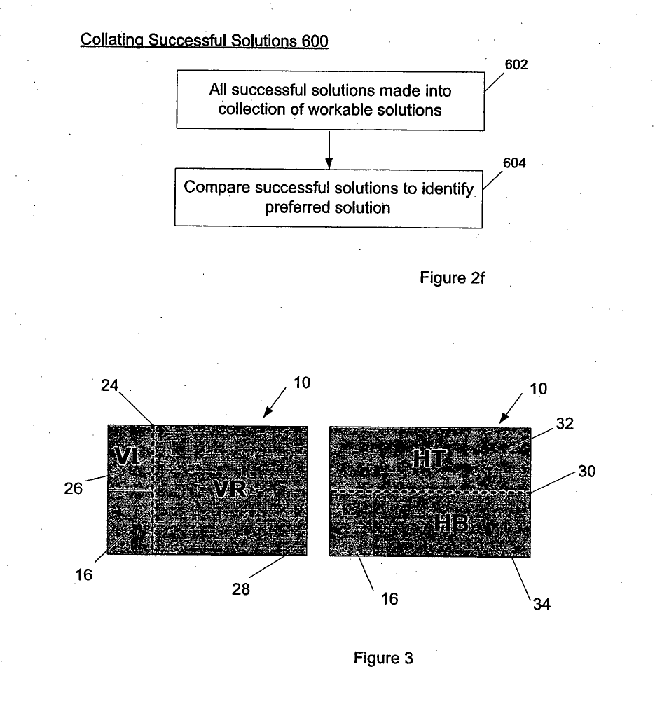

### DETAILED DESCRIPTION OF CERTAIN EMBODIMENTS OF THE INVENTION

The method seeks to calculate an efficient way of printing any number of different sized components on the same press sheet.

Information Collecting 100 The method begins with the user entering the specifications of the Component objects that need to be printed 102. Each Component object represents a type of rectangular component that needs to be printed for a particular Project. Properties of the Component objects include:
width
height
name (the component input name)
grain (the grain direction of the component, either “vertical”, “horizontal” or “either”)
requested quantity (the number of completed Component objects requested)
edge bleed values (the distance from each edge of the Component object to the image area—an image bleeds if the image runs over the edge, or alternatively the image may be a certain distance from the inside of the edge)
trim allowance (the distance from each edge of the finished product area of the component to the working area of the component which may include offcut allowances required by postpress processes)

A Plant object is also created by the user specifying the equipment, resources and processes available for production 106, and may be created by the recalling of such information from a file or database. More specifically, the Plant object includes specifications of the Stock to be used for the production of the Component, this includes:
sheet width
sheet height
sheet grain (either “vertical” or “horizontal”)

The Plant object also includes specifications of the Press or Presses for production of the Component objects including:
sheet size capabilities of the press (maximum and minimum sheet size, etc)
image area capabilities of the press (non-image allowance on each edge of the sheet)
post-press sheet trim requirements (minimum trim allowance on each edge of the sheet if it falls inside the product)

The Plant object also includes specifications of the PressProductionMethod used, including:
one-sided, sheetwise, work and turn, work and tumble, or perfected.

Combined, the Component objects, Plant object and an empty collection of Solution objects create a single Project 108. The Project is initiated and calls upon the SolutionFactory.

Pre-Processing 200

Before arrangement attempts are made on the Sheet, some pre-processing is performed by the SolutionFactory.

Each Component object makes a group of ComponentInstance objects 201, each representing one actual instance of the Component object. ComponentInstance objects inherit from their parent Component object all of the above characteristics, so that all ComponentInstance objects from the same parent share common properties. ComponentInstance objects also have their individual instance properties, which include:
rotation (the rotation from the original position, either 0°, 90°, 180° or 270°)
x (x-coordinate of the lower left hand corner)
y (y-coordinate of the lower left hand corner)
instance number (the number of this instance of the parent Component object)

Each rectangular ComponentInstance object could just require trimming, or could require trimming and folding and possibly slitting, perforating or gluing, or could require trimming and laminating, embossing, creasing, foil stamping, or shape cutting. After folding it may require binding, shape cutting or further trimming.

The SolutionFactory also calculates a collection of ComponentSize groups 202. A ComponentSize group is calculated for every combination of Components for a Project, given each Component's size-grain-bleed symmetry without duplication. For efficiency Components of the same size are not distinguished unless necessary due to differing grain or bleed differences. Printing of Components sharing the same specifications will be very common, and processing them as separate entities will decrease the efficiency of the method, when in fact they can be processed in the same way without a loss in sheet usage.

It is industry practice in printing that common sized components should not be rotated arbitrarily in respect to one another. Following this practice, rotation of different Components of the same size in respect to one another is not performed. One exception is made to allow rotation of a Component when placing it if the Component doesn't otherwise fit due to dimensional constraints, or image or trim area constraints, and the rotation is allowed by the grain.

The number of ComponentSize groups will be limited by the grain requirements of the Component. The possible rotation of a Component is limited, and each ComponentSize must rotate such a Component until the grain matches the grain of the sheet. Where a Component has no grain limitation, a separate ComponentSize is created for each rotation of 0° and 90° from the original rotation. Furthermore, if the Component has an image bleed requirement that is not symmetrical further ComponentSize groups are created for rotations of 180° and 270° from the original rotation. Alternatively, if a Component is constrained to a specific grain direction and has non-symmetrical bleeds, ComponentSize groups are created for all rotations that match the grain, either 0° and 180°, or 90° and 270°.

Once all the ComponentSize groups are created, the Components within each group are ordered in size from largest to smallest 204.

Next, ComponentQuantities (ratios) are calculated. This includes a most efficient ratio that is the maximum possible ratio of the different ComponentInstances that could be printed on the Sheet before the total area of the ComponentInstances exceeds the area of the press sheet. Total area of the ComponentInstances includes consideration of the bleed requirement of each component.

From the Components of a Project, the Component that requires the smallest quantity is assigned the number 1 in the ratio. The resulting proportional quantity required of the remaining Components is calculated, using only whole numbers. This becomes the simplest efficient (basic) ratio 206. The Component requiring the smallest quantity is then assigned the number 2, and the remaining proportional quantities of the other Components is again calculated to create the second efficient ratio. This is again repeated, assigning the Component requiring the smallest quantity 3 and so on. This is repeated until the resulting combined area of each Component in the next ratio to be calculated exceeds the available press Sheet area 208.

The Multiplier is the number that the simplest efficient ratio of Component quantities is multiplied by. The Multiplier is initially set to one and incremented by one. This continues until the LastMultiplier is reached. The LastMultiplier sets the upper bound of possible ratios, that ratio being the potentially most efficient ratio and the starting point for testing possible solutions 210.

### EXAMPLE A

### Creating Ratios

When desired quantities are 1000×A4, 2000×A5 and 3000×DL, the simplest (efficient) ratio with the Multiplier equal to 1 is:
1:2:3 (1000 sheets required).

The next efficient ratio, with the Multiplier equal to 2 is:
2:4:6 (500 sheets required)

The next efficient ratio, with the Multiplier equal to 3 is:
3:6:9 (334 sheets required)
   and so on until the LastMultipler is reached.

Inefficient ratios for between ratios created by Multipliers are also calculated.

Inefficient ratios between Multiplier=1 and one of each Component are:
1:2:2 (largest of 1000, 1000, 1500 sheets required)
1:1:2 (largest of 1000, 2000, 1500 sheets required)
1:1:1 (largest of 1000, 2000, 3000 sheets required)—most inefficient workable ratio

Inefficient ratios between Multiplier=1 and Multiplier=2 are:
2:3:4 (largest of 500, 667, 750 sheets required)
2:3:5 (largest of 500, 667, 600 sheets required)
2:4:5 (largest of 500, 500, 600 sheets required)

Inefficient ratios between Multiplier=2 and Multiplier=3 are also calculated and so on.

While some of the ratios between Multipliers (inefficient ratios) seem inefficient, they may still be practical if none of the ratios calculated using the Multiplier (efficient ratios) cannot be achieved on a given sheet.

A QuantityGroup is the name given to a group of ComponentQuantities (ratios) between two Multipliers, including the ratio calculated from one of the Multipliers.

### EXAMPLE B

### Calculating the LastMultiplier

To produce the above quantities on a press Sheet with dimensions of 630×440, calculation of the LastMultipler is as follows:

| | |
|---|---|
| Sheet area: | 630 × 440 = 277,200 |
| Ratios: | 1:2:3, 2:3:4, 2:3:5, 2:4:5, 2:4:6 etc . . . |
| Component area: | A4 = 210 × 297 = 62,370 |
| | A5 = 148 × 210 = 31,080 |
| | DL = 99 × 210 = 20,790 |
| Component ratio area: | Multiplier = 1 |
| | 1:2:3 = 62,370 + (2 × 31,080) + (3 × 20,790) = |
| | 186,900 (OK) |
| | Multiplier between 1 and 2 |
| | 2:3:4 = (2 × 32.370) + (3 × 31,080) + |
| | (4 × 20,790) = 301,140 |
| | (NOT OK, larger than the available 277,200 |
| | Sheet area) |
| | Therefore LastMultiplier = 1 |

Starting with the largest ratio and systematically working downwards towards the smallest in steps to narrow the range, not one-by-one, TestSolutions are calculated 212. TestSolutions are essentially collections of ComponentInstances created by the combination of a ComponentSize group and a ComponentQuantity.

As inherited from their constituent ComponentSize group, unless there are grain constraints a TestSolution for up to the four possible orientations of each Component is created. Each ComponentInstance from the same parent Component should be the same orientation within each collection. Thus ComponentInstances from the same parent Component will default to the same orientation and will only have a variation if forced by the Sheet dimension or bleed or trim constraints when an attempt is made to arrange the ComponentInstance, and if allowed by the grain.

### EXAMPLE C

### Collecting TestSolution for Example A

For the Example A above, the following TestSolution collection will be created for the 1:2:3 ratio (0=Portrait, 90=Landscape):
A4-0, A5-0, A5-0, DL-0, DL-0, DL-0 (all portrait)
A4-90, A5-0, A5-0, DL-0, DL-0, DL-0 (1 component type landscape)
A4-0, A5-90, A5-90, DL-0, DL-0, DL-0 (1 component type landscape)
A4-0, A5-0, A5-0, DL-90, DL-90, DL-90 (1 component type landscape)
A4-0, A5-90, A5-90, DL-90, DL-90, DL-90 (1 component type portrait)
A4-90, A5-0, A5-0, DL-90, DL-90, DL-90 (1 component type portrait)
A4-90, A5-90, A5-90, DL-0, DL-0, DL-0 (1 component type portrait)
A4-90, A5-90, A5-90, DL-90, DL-90, DL-90 (all landscape)

### EXAMPLE D

Given the following specifications for a Project where:

| | |
|---|---|
| Component A | w = 210 |
| | h = 297 |
| | grain = either |
| | no bleeds (symmetrical) |
| | quantity = 1000 |
| Sheet: | w = 900 |
| | h = 640 |

The LastMultiplier is calculated to be 9 making the simplest most efficient ratio 9 (at best, 9 ComponentInstances can fit onto the one sheet). ComponentSizes are A-0 and A-90 as there is no grain requirement and no bleed requirement. The TestSolution collection for the simplest most efficient ratio is:
A-0:A-0, A-0, A-0, A-0, A-0, A-0, A-0, A-0, A-0
A-90:A-90, A-90, A-90, A-90, A-90, A-90,A-90,A-90, A-90

### EXAMPLE E

Given the following specifications for a Project where:

| | |
|---|---|
| Component A: | w = 210 |
| | h = 297 |
| | grain = either |
| | no bleeds (symmetrical) |
| | quantity = 1000 |
| Component B: | w = 210 |
| | h = 297 |
| | grain = either |
| | no bleeds (symmetrical) |
| | quantity = 1000 |
| Component C: | w = 210 |
| | h = 297 |
| | grain = either |
| | no bleeds (symmetrical) |
| | quantity = 1000 |
| Sheet: | w = 900 |
| | h = 640 |

The LastMultiplier is calculated to be 3, making the starting ratio 3:3:3. As all the characteristics for all three components are the same, processing is simplified by treating them the same way. Since there is no grain limitation, rotations of 0° and 90° are included in the ComponentSize combinations, but 180° and 270° are not as the bleed is symmetrical. Accordingly, ComponentSizes are just A-0 and A-90. Being treated as the same component, the orientation for all three components remains the same for all TestSolutions. The TestSolution collection for the ratio 3:3:3 is:
A-0: A-0, A-0, A-0, B-0, B-0, B-0, C-0, C-0, C-0
A-90: A-90, A-90, A-90, B-90, B-90, B-90,C-90, C-90, C-90

### EXAMPLE F

Given the following specifications for a Project where:

| | |
|---|---|
| Component A: | w = 210 |
| | h = 297 |
| | grain = either |
| | no bleeds (symmetrical) |
| | quantity = 1000 |
| Component B: | w = 148 |
| | h = 210 |
| | grain = either |
| | no bleeds (symmetrical) |
| | quantity = 2000 |
| Component C: | w = 99 |
| | h = 210 |
| | grain = either |
| | no bleeds (symmetrical) |
| | quantity = 3000 |
| Sheet: | w = 900 |
| | h = 640 |

The LastMultiplier is calculated to be 3, making the starting ratio 3:6:9. As all three Components are different, processing cannot be reduced by treating them the same, making the ComponentSizes as set out below on the left. The resulting TestSolutions collection for the ratio 3:6:9 is:
A-0, B-0, C-0: A-0, A-0, A-0, B-0, B-0, B-0, B-0, B-0, B-0, C-0, C-0, C-0, C-0, C-0, C-0, C-0, C-0, C-0
A-0, B-0, C-90: A-0, A-0, A-0, B-0, B-0, B-0, B-0, B-0, B-0, C-90, C-90, C-90, C-90, C-90, C-90, C-90, C-90, C-90
A-0, B-90, C-0: A-0, A-0, A-0, B-90, B-90, B-90, B-90, B-90, B-90, C-0, C-0, C-0, C-0, C-0, C-0, C-0, C-0, C-0
A-0, B-90, C-90: A-0, A-0, A-0, B-90, B-90, B-90, B-90, B-90, B-90, C-90, C-90, C-90, C-90, C-90, C-90, C-90, C-90, C-90
A-90, B-0, C-0: A-90, A-90, A-90, B-0, B-0, B-0, B-0, B-0, B-0, C-0, C-0, C-0, C-0, C-0, C-0, C-0, C-0, C-0
A-90, B-0, C-90: A-90, A-90, A-90, B-0, B-0, B-0, B-0, B-0, B-0, C-90, C-90, C-90, C-90, C-90, C-90, C-90, C-90, C-90
A-90, B-90, C-0: A-90, A-90, A-90, B-90, B-90, B-90, B-90, B-90, B-90, C-0, C-0, C-0, C-0, C-0, C-0, C-0, C-0, C-0
A-90, B-90, C-90: A-90, A-90, A-90, B-90, B-90, B-90, B-90, B-90, B-90, C-90, C-90, C-90, C-90, C-90, C-90, C-90, C-90, C-90

### EXAMPLE G

Given the following specifications for a Project where:

| | |
|---|---|
| Component A: | w = 210 |
| | h = 297 |
| | grain = either |
| | no bleeds (symmetrical) |
| | quantity = 1000 |
| Component B: | w = 148 |
| | h = 210 |
| | grain = either |
| | no bleeds (symmetrical) |
| | quantity = 1000 |
| Component C: | w = 99 |
| | h = 210 |
| | grain = either |
| | no bleeds (symmetrical) |
| | quantity = 3000 |
| Component D: | w = 148 |
| | h = 210 |
| | grain = either |
| | no bleeds (symmetrical) |
| | quantity = 1000 |
| Sheet: | w = 900 |
| | h = 640 |

The LastMultiplier is calculated to be 3, making the starting ratio 3:3:9:3. As Component B and D are the same, processing is simplified by treating them the same way, making the ComponentSizes all unique combinations of A, B, and C allowing for 90° rotations of each component. The resulting TestSolutions for the ratio 3:3:9:3 are:
A-0, B-0, D-0, C-0: A-0, A-0, A-0, B-0, B-0, B-0, D-0, D-0, D-0, C-0, C-0, C-0, C-0, C-0, C-0, C-0, C-0, C-0
A-0, B-0, D-0, C-90: A-0, A-0, A-0, B-0, B-0, B-0, D-0, D-0, D-0, C-90, C-90, C-90, C-90, C-90, C-90, C-90, C-90, C-90
A-0, B-90, D-90, C-0: A-0, A-0, A-0, B-90, B-90, B-90, D-90, D-90, D-90, C-0, C-0, C-0, C-0, C-0, C-0, C-0, C-0, C-0
A-0, B-90, D-90, C-90: A-0, A-0, A-0, B-90, B-90, B-90, D-90, D-90, D-90, C-90, C-90, C-90, C-90, C-90, C-90, C-90, C-90, C-90
A-90, B-0, D-0, C-0: A-90, A-90, A-90, B-0, B-0, B-0, D-0, D-0, D-0, C-0, C-0, C-0, C-0, C-0, C-0, C-0, C-0, C-0
A-90, B-0, D-0, C-90: A-90, A-90, A-90, B-0, B-0, B-0, D-0, D-0, D-0, C-90, C-90, C-90, C-90, C-90, C-90, C-90, C-90, C-90
A-90, B-90, D-90, C-0: A-90, A-90, A-90, B-90, B-90, B-90, D-90, D-90, D-90, C-0, C-0, C-0, C-0, C-0, C-0, C-0, C-0, C-0
A-90, B-90, D-90, C-90: A-90, A-90, A-90, B-90, B-90, B-90, D-90, D-90, D-90, C-90, C-90, C-90, C-90, C-90, C-90, C-90, C-90, C-90
   ArrangeTesting Rules 300

Next, testing rules, such as a preferred position rule, preferred cut orientation rule and a preferred sheet resulting from a cut rule are set 301. Following these rules, TestSolutions are tested. Starting from the first TestSolution of the potentially most efficient ratio, an attempt is made to arrange the first ComponentInstance (which is the largest) of the TestSolution according to a preferred position rule such as in the bottom left hand corner of the Sheet, the Sheet having been adjusted for the printing method specified 302. If the ComponentInstance does not fit in its current orientation, if allowed by the grain of the ComponentInstance, an attempt is made to arrange the first ComponentInstance at a 90° orientation 304. If the ComponentInstance still does not fit within the Sheet in this orientation and has an image area that is not symmetrical, an attempt is made to arrange the ComponentInstance in a 180° orientation. If this is still not successful, an attempt is made to arrange the ComponentInstance at a 270° orientation.

If all attempts to arrange the ComponentInstance fails in all orientations tested, then the process is repeated using a new Sheet. If there are no further Sheets to be tested, the TestSolution fails 306.

If the attempt to arrange the ComponentInstance is successful, in that it fits, the component is also adjusted for bleed and component trim. If the ComponentInstance still fits on the sheet and the bleed trim and page trim area fits within the sheet's image area and trim area the arrangement is successful.

If the attempt to arrange the ComponentInstance is successful without rotation and the ComponentInstance is rotatable with the grain specification set to “either”, the ComponentInstances of the TestSolution are checked to see whether the collection contains another ComponentInstance of the same size and rotation where the grain is not “either”. If there exists such a ComponentInstance, this ComponentInstance is swapped for the original, more flexible, ComponentInstance that was successfully arranged 308.

Once an attempt to arrange the ComponentInstance is successful (or was swapped by a less flexible ComponentInstance), the position properties of the ComponentInstance on the sheet including any necessary offsets for image and trim are set 310. The TestSolution's required area is also updated, removing the area of the newly placed ComponentInstance.

If all ComponentInstances of a TestSolution have been arranged, then the TestSolution is complete and successful 312. If there are further TestSolutions that have not been tested, the arrangement rules continue processing these TestSolutions to see of they too can be successful 313. This continues until the collection of TestSolutions is exhausted or until the time allocated for testing has expired.

If any ComponentInstances remain unarranged within the TestSolution currently being tested, the solution is incomplete and processing continues.

As shown in FIG. 3, each arrangement needs to be divisible from the Sheet 10 by straight (guillotine) cuts. Two sets of possible cut sheets can result from a successful arrangement. The first set of possible cut sheets result from a vertical cut 24 from the right edge of the arranged ComponentInstance 16. These two cut sheets would be vertical left (VL) 26 and vertical right (VR) 28. The second set of possible cut sheets result from a horizontal cut 30 from the top edge of the arranged ComponentInstance 16. These two cut sheets would be horizontal top (HT) 32 and horizontal bottom (HB) 34.

Each one of the possible cut sheets may become a new sheet for future arrangement attempts. The testing of these sheets may follow either the Simple Test 400 and/or the Exhaustive Test 500.

Simple Test 400

The aim of the Simple Test 400 is to find some basic solutions quickly. These tests also are the starting point for the alternate Exhaustive Test 500.

Based on factors, such as the dimensions of the Sheet to be tested, testing rules are set. Preferred position rule stipulates one default arrangement rule such as bottom left. Preferred cut orientation rule stipulates that the cut is either vertical or horizontal. The preferred sheet resulting from a cut rule stipulates which of the two possible resulting cut sheets is given priority for further testing. For example, a vertical cut may be set as a priority and the resulting right cut sheet (VR) is set as the next sheet to be used for further testing. The resulting left cut sheet (VL) would be used for further testing only after the right cut sheet (VR), and any further cut sheets it produces, have been tested.

The preferred cut rule is applied and cut sheets are calculated 402. The cut sheets are then tested to see if they are too small to fit even the smallest ComponentInstance, and if so they are discarded. Then following the preferred sheet rule one of the two cut sheets is selected as having priority 404. Following the preferred position rule, an attempt is made to arrange the next unarranged ComponentInstance of the TestSolution being tested on the selected cut sheet 406.

If as a result of this placement all the ComponentInstances of the TestSolution are successfully arranged onto the sheet, then the TestSolution succeeds 410.

Alternatively, if the arrangement of the ComponentInstance succeeds and there remain unarranged ComponentInstances in the TestSolution, processing continues 412. Again the testing rules are applied and further cut sheets are created, 402 tested for usefulness, and prioritised for use by the preferred sheet rule 404.

Alternatively, if the placement was unsuccessful, a cut sheet that was previously made and not yet tested or used is selected 408. The preferred position rule is then applied to this sheet 406 and testing continues in the same way.

Processing continues in this manner, each time placing the next unarranged ComponentInstance on the selected cut sheet 406. This processing path is considered the “mainroute” of this test, and unlike the Exhaustive Test 500, there are no cloned routes (described below).

As cut sheets are discarded because they are too small to be used the total potential sheet area is recalculated and compared to the total area required by the unarranged ComponentInstances. If the total remaining sheet area is smaller than the total area of the unarranged ComponentInstances, then this TestSolution has failed 416.

On the failure or success of any TestSolution, if there exists at least one further TestSolution that has not been processed, the testing rules begin again on the next TestSolution following the Simple Test 400 method 418.

Exhaustive Test 500

This method is designed to try every variation possible, so that the testing rules stipulate a preferred order of testing possible alternatives rather than selecting just one. For example, if there is a choice of a vertical or horizontal cut, both sets of cut sheets are calculated and tested in a preferred order. The Exhaustive Test 500 may be performed after the Simple Test 400 has finished in the hope of achieving more efficient solutions.

Each of the four possible cut sheets (VL, VR, HT and HB) are calculated 502 and then examined to see if they are too small to fit even the smallest unarranged ComponentInstance remaining unarranged in the TestSolution. If so, this cut sheet is discarded 504.

After disqualifying sheets that are too small, the possible remaining cut sheets from either cut are:
2 sheets
   from vertical cut, VL & VR; or
   from horizontal cut, HT & HB
1 sheet
   from vertical cut, either VL or VR; or
   from horizontal cut, either HT or HB
No sheets

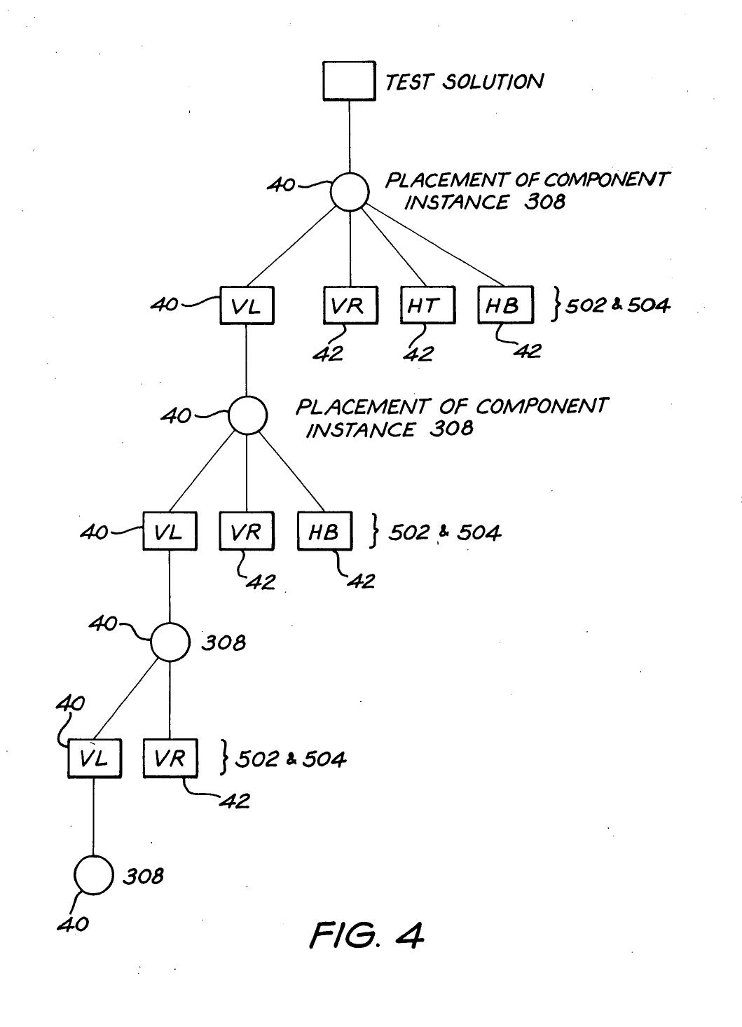

FIG. 4 illustrates a possible processing path of the resulting cut sheets which continues down solution paths that are divided out when a further successful arrangement of a ComponentInstance is made, creating even further cut sheets. An entire path is traversed, possibly making further branches along the way. The first solution processed down an entire path is considered the “mainroute” for that TestSolution and is marked 40. This mainroute may be identical to the “mainroute” as calculated for the same TestSolution using the Simple Test 400. If the Simple Test 400 was performed first, the mainroute calculated from the Simple Test 400 may be used here again rather than re-calculated.

Once the mainroute path has been exhausted, processing will begin at one of the branches that was created off the mainroute but not processed 42. These branches are considered “clonedroutes”. The processing of these clonedroutes will inturn also continue their descent down a complete path, starting from a branch and possibly also creating further branches along the way. This will continue until either all possible branches have been exhausted and failed (in which case processing would begin on any remaining TestSolutions that have not been explored) or until the required number of arrangement variations have been found as determined by the “MaximumVariation” rule.

No Sheets If there are no alternative cut sheets that are large enough to fit even the smallest ComponentInstance, and the total remaining sheet area is smaller than the total of the area of the unarranged ComponentInstances, then this branch or mainroute of the TestSolution has failed 506.

If there are alternative cut sheets created from a previous arrangement of a ComponentInstance (i.e. a branch—or a branch of a branch etc . . . ), then arrangement processing continues along one of those branches 508. The branch may be selected according to the testing rules.

If there are no alternative cut sheets (i.e. all possible branches—or branch of a branch etc—from the mainroute of the TestSolution have been completely exhausted) and there exists in the TestSolution collection at least one TestSolution that has not been processed, the arrangement rules begin again on the next untested TestSolution 510.

1 Sheet from Both Cut Directions

Where cutting of the sheet having the arranged ComponentInstance results in only 1 sheet for either cut direction, vertical and horizontal, the cut sheet that has a smaller area is also discarded, and no longer considered within the pool of cut sheets available 512. This is done on the condition that the testing rules for both sheets are the same (i.e. arrangement always begins in the bottom left hand corner). This helps to increase the efficiency of the method by immediately removing a possible solution that will not be the most efficient, and only processing the cut sheet created from the other cut direction.

1 Sheet or 2 Sheets from Both Cut Directions

The resulting possible cut sheets from the arrangement of the ComponentInstance is then analysed to determine the direction the path is to be processed. Testing rules are incorporated into the analysis. These rules may stay the same or may be re-set based in the current status of the testing.

The preferred cut rule may be set based on the sheet orientation (landscape or portrait) and the arrangement position. These rules are chosen by their ability to produce good results quickly. For each arrangement the testing could continue on one of the four possible paths, depending on the direction of the cut and the priority order given to the each possible resulting cut sheets 514.

The preferred sheet rule involves selecting a priority cut sheet and ordering the remaining cut sheets clonedroutes 42. Each clonedroute 42 is a branch created by a non-prioritised cut sheet and their order is set according to the preferred cut sheet rules. As processing continues down a mainroute, any further cut sheets created along that path are added to the cut sheet collection being ordered in a similar way. For example, a clonedroute 42 created by the creation of a VL cut sheet may also create further vertical cut sheets due to the arrangement of a further ComponentInstance and a further vertical cut. These further cut sheets will be arranged with the new VL cut sheet first as stipulated by the preferred cut sheet rule and the VR cut sheet second. When these branches are explored, the processing of the new VL cut sheet branch will be exhausted before processing begins on the new VR cut sheet branch.

By following these rules and exhausting the mainroute 40 first, before processing the branches, processing will be initially conducted on what is considered the best possible result given the testing rules.

The cut sheets having been analysed, the next step in the mainroute 40 is determined 516. Any branch not a part of the mainroute 40 are considered a clonedroute 42. These clonedroutes 42 will have the same properties as the mainroute 40 up to this point. These clonedroutes 42 are ordered for later processing 518. Processing now continues by applying the testing rules to the cut sheet chosen as the next step in the mainroute 40. The arrangement rules repeat, taking the next unarranged ComponentInstance for that TestSolution 520.

Collating Successful Solutions

Finally, once all the TestSolutions have been processed and exhausted, the results of successful TestSolutions are made into a collection of workable solutions 602 each called Solution objects, which include the following properties:
percentage sheet use (total area of the sheet covered by the area of the ComponentInstances)
collection of ComponentInstances with all their properties set
estimated cost of manufacturing
   These are then compared to find the most preferable solution, which will ordinarily be the most efficient solution based on percentage sheet use or the cheapest based on the estimated cost of manufacturing 604.

The method may include a dialog box to show the user the state of the calculation during processing, such as current number of solutions found, the best efficiency of those found.

It will be appreciated by persons skilled in the art that numerous variations and/or modifications may be made to the invention as shown in the specific embodiments without departing from the spirit or scope of the invention as broadly described. For example, a number of components from a TestSolution may be pre-arranged on the sheet, and the remaining components placed on the sheet according to the method. The pre-arranged components may be arranged manually or automatically. The method would be performed on ratios that are calculated for all components in the TestSolution not already pre-arranged on the sheet. The present embodiments are, therefore, to be considered in all respects as illustrative and not restrictive.

1. A method for arranging components on a sheet, the method comprising:
entering specifications of each type of component, including dimensions and quantity;
entering specifications of the sheet, including dimensions;
calculating a whole number ratio of components that is proportional to the quantity requirement of the components;
multiplying the calculated whole number ratio by the largest factor that results in the calculated total area of the components in the ratio not exceeding the calculated area of the sheet;
setting testing rules, including a preferred position rule, preferred cut orientation rule and a preferred sheet resulting from a cut rule; and
testing the ratio by attempting to arrange components as required by the ratio on the sheet by applying the testing rules.

2. A method according to claim 1, wherein the testing is performed through the simulation of arranging components on the sheet in an electronic environment.

3. A method according to claim 2, further comprising entering specifications of a plant that will arrange the components onto the sheet, including possible sheet sizes that can be used by the plant, trim allowances and non-image allowances for these sheets, and possible press production methods.

4. A method according to claim 1, wherein each component is rectangular in shape, and is folded, trimmed, bound, laminated, embossed, foil stamped, perforated or shape cut.

5. A method according to claim 1, wherein the factor is a whole number.

6. A method according to claim 5, wherein the calculating a whole number ratio includes consideration of the bleed requirement of the component when calculating the area of the component.

7. A method according to claim 6, wherein the calculating further includes calculating further ratios to create a list of ratios, wherein all ratios of components in the list are whole number ratios, are proportional to the quantity requirements of the components, and the total area of the components in each ratio does not exceed the area of the sheet.

8. A method according to claim 1, further comprising calculating a collection of all possible component orientation combinations for the ratio given the grain, and bleed symmetry specification of each component.

9. A method according to claim 8, further comprising ordering the components within each combination, in order of largest to smallest based on component dimensions.

10. A method according to claim 9, further comprising expanding each combination, to specify for each component in the combination a number of instances as required by the corresponding ratio and the orientation of each instance.

11. A method according to claim 10, further comprising calculating the rotation of components in an expanded combination based on testing rules.

12. A method according to claim 1, wherein the testing rules are based on the entered specifications.

13. A method according to claim 12, wherein an attempt to arrange a component on the sheet includes testing to see whether the component fits within the area of the sheet.

14. A method according to claim 13, wherein a preferred position rule specifies a preferred position that an attempt to arrange a component is to be made.

15. A method according to claim 13, wherein a preferred cut orientation rule specifies the orientation of a cut made to remove a successfully arranged component from the sheet or sheet resulting from a previous cut.

16. A method according to claim 15, wherein a preferred sheet resulting from a cut rule specifies which cut sheet testing of the ratio will continue on.

17. A method according to claim 1, further comprising identifying all combinations that can be successfully arranged on the sheet.

18. A method according to claim 17, further comprising calculating the percentage sheet usage by comparing the calculated total area of the components arranged on the sheet to the calculated sheet area for each successful arrangement.

19. One or more processor readable storage devices having processor readable code embodied on the processor readable storage devices, the processor readable code for programming one or more processors to perform a method of arranging components on a sheet, the method comprising:
receiving specifications of each type of component, including dimensions and quantity;
receiving specifications of the sheet, including dimensions;
calculating a whole number ratio of components that is proportional to the quantity requirement of the components;
multiplying the calculated whole number ratio by the largest factor that results in the calculated total area of the components in the ratio not exceeding the calculated area of the sheet;
setting testing rules, including a preferred position rule, preferred cut orientation rule and a preferred sheet resulting from a cut rule; and
testing the ratio by attempting to arrange components as required by the ratio on the sheet by applying the testing rules.

20. A system for arranging components on a sheet, comprising:
means for receiving specifications of each type of component, including dimensions and quantity:
means for receiving specifications of the sheet, including dimensions;
means for calculating a whole number ratio of components that is proportional to the quantity requirement of the components; and
means for multiplying the calculated whole number ratio by the largest factor that results in the calculated total area of the components in the ratio not exceeding the calculated area of the sheet;
means for setting testing rules, including a preferred position rule, preferred cut orientation rule and a preferred sheet resulting from a cut rule; and
means for testing the ratio by attempting to arrange components as required by the ratio on the sheet by applying the testing rules.

21. A system for arranging components on a sheet, the system comprising:
a first receiving object configured to receive specifications of each type of component, including dimensions and quantity;
a second receiving object configured to receive specifications of the sheet, including dimensions;
a calculating object configured to calculate a whole number ratio of components that is proportional to the quantity requirement of the components;
a multiplying object configured to multiply the calculated whole number ratio by the largest factor that results in the calculated total area of the components in the ratio not exceeding the calculated area of the sheet;
a setting object configured to set testing rules, including a preferred position rule, preferred cut orientation rule and a preferred sheet resulting from a cut rule; and
a testing object configured to test the ratio by attempting to arrange components as required by the ratio on the sheet by applying the testing rules.
